(19) United States
(12) Patent Application Publication
(10) Pub. No.: US 2014/0088245 A1
(43) Pub. Date: Mar. 27, 2014

(54) HYDROPHOBIC POLYESTER POLYCARBONATE POLYOLS FOR USE IN POLYURETHANE APPLICATIONS

(71) Applicants: Harpreet Singh, Pearland, TX (US); Jorge Jimenez, Lake Jackson, TX (US); William H. Heath, Lake Jackson, TX (US); Woo-Sung Bae, Midland, MI (US); Amarnath Singh, Pearland, TX (US)

(72) Inventors: Harpreet Singh, Pearland, TX (US); Jorge Jimenez, Lake Jackson, TX (US); William H. Heath, Lake Jackson, TX (US); Woo-Sung Bae, Midland, MI (US); Amarnath Singh, Pearland, TX (US)

(73) Assignee: Dow Global Technologies LLC, Midland, MI (US)

(21) Appl. No.: 14/005,928

(22) PCT Filed: Mar. 30, 2012
(86) PCT No.: PCT/US12/31462

§ 371 Date: Nov. 26, 2013

Related U.S. Application Data
(60) Provisional application No. 61/470,343, filed on Mar. 31, 2011.

(51) Int. Cl. C09D 175/06; C08G 18/34; C08G 64/02

(52) U.S. Cl. CPC C09D 175/06; C08G 64/0208; C08G 18/348
USPC 524/590; 528/302; 528/80

(57) ABSTRACT

Disclosed are hydrophobic polyester-polycarbonate polyols which are the reaction product of (a) a polyester polyol and (b) one or more polycarbonate polyols. The polyester polyol (a) is the reaction product of: (i) one or more hydrophobic monomers, (ii) one or more organic acids, and (iii) one or more alcohols having an OH functionality of 2 or more. The polyester-polycarbonate polyols may be both amorphous and liquid at room temperature and have excellent hydrolytic stability. The hydrolytic and chemical performance of the polyester-polycarbonate polyols described herein is superior to that of commercially available hydrophobically modified polyester polyols and to that of commercially available polyester-polycarbonate polyols as described herein.

### BACKGROUND OF THE INVENTION

1. Field of the Invention

Embodiments of the invention generally relate to elastomers and prepolymers. More particularly, embodiments of the invention relate to elastomers and prepolymers having excellent hydrolytic stability.

2. Description of the Related Art

Polycarbonate polyols are high performance polyols used for applications requiring excellent ultraviolet (UV), hydrolytic, chemical and thermo oxidative stability. Polyesters generally have both good UV and thermo oxidative stability but suffer from poor hydrolytic stability. Furthermore, both polycarbonate and polyester polyols are crystalline in nature and generally solid at room temperature which introduces processing constraints for various coating, adhesive, sealant and elastomer (C.A.S.E.) applications which require liquid polyols.

Currently, liquid polycarbonate polyols produced from mixtures of diols are used but these liquid polycarbonate polyols generate a highly viscous material which still has some residual crystallinity at low temperatures (e.g., −5 degrees Celsius) and are very expensive to produce. Copolymers of polycarbonate and ester polyols provide a cost-effective route for producing liquid polyols that have most of the desired attributes but still suffer from poor hydrolytic stability due to ester linkages present in the backbone.

Therefore there is a need for polyols that are liquids at room temperature and have excellent hydrolytic stability.

### SUMMARY OF THE INVENTION

Embodiments of the invention generally relate to elastomers and prepolymers. More particularly, embodiments of the invention relate to prepolymers useful for making elastomers as well as polyurethanes made from the polyols having excellent hydrolytic stability. Disclosed are hydrophobic polyester-polycarbonate polyols which are the reaction product of (a) a polyester polyol and (b) one or more polycarbonate polyols. The polyester polyol (a) is the reaction product of: (i) one or more hydrophobic monomers, (ii) one or more organic acids, and (iii) one or more alcohols having an OH functionality of 2 or more. The disclosed hydrophobic polyester-polycarbonate polyols may include one or more of the following aspects:
one or more hydrophobic monomers comprising one or more of dimer acids, dimer diols, hydroxy stearic acid, hydroxymethylated fatty acids, or esters thereof;
one or more organic acids comprising one or more of phthalic acid, isophthalic acid, terephthalic acid, trimellitic acid, tetrahydrophthalic acid, hexahydrophthalic acid, tetrachlorophthalic acid, oxalic acid, adipic acid, azelaic acid, sebacic acid, succinic acid, malic acid, glutaric acid, malonic acid, pimelic acid, suberic acid, 2,2-dimethylsuccinic acid, 3,3-dimethylglutaric acid, 2,2-dimethylglutaric acid, maleic acid, fumaric acid, itaconic acid, or fatty acids; and
one or more alcohols having an OH functionality of 2 or more comprising one or more of ethylene glycol, propylene glycol, 1,2-butylene glycol, 2,3-butylene glycol, 1,3-propanediol, 1,3-butanediol, 1,4-butanediol, 1,6-hexanediol, neopentylglycol, 1,2-ethylhexyldiol, 1,5-pentanediol, 1,10-decanediol, 1,3-cyclohexanedimethanol, 1,4-cyclohexanedimethanol (CHDM), glycerine, or trimethylolpropane;

In some embodiments, the disclosed hydrophobic polyester-polycarbonate polyols are liquid at room temperature and include one or more of the following aspects:
adipic acid and at least one of 1,4-butanediol and 1,6-hexanediol;
one or more polycarbonate polyols that are the reaction product of at least (a) one or more alkane diols having 2 to 20 carbon atoms with a number average molecular weight between 500 and 3,000, and (b) at least one carbonate compound;
one or more alkane diols selected from one or more of 1,3-propanediol, 1,4-butanediol, 1,5-pentanediol, 1,6-hexandiol, 1,7-heptanediol, 1,2-dodecanediol, cyclohexanedimethanol, 3-methyl-1,5-pentanediol, 2,4-diethyl-1,5-pentanediol, bis(2-hydroxyethyl)ether, bis(6-hydroxyhexyl)ether, or short-chain C₂, C₃ or C₄ polyether diols having a number average molecular weight of less than 700 g/mol;
at least one carbonate compound selected from one or more of alkylene carbonates, diaryl carbonates, dialkyl carbonates, hexanediol bis-chlorocarbonates, phosgene, or urea.

Also disclosed is a hydrophobic prepolymer or hydrophobic elastomer prepared from a reaction mixture comprising (a) a hydrophobic polyester-polycarbonate polyol, and (b) one or more organic polyisocyanate components. The disclosed hydrophobic prepolymer or hydrophobic elastomer may include one or more of the following aspects:
one or more chain extenders selected from one or more of ethylene glycol, diethylene glycol, 1,3-propane diol, 1,3-butanediol, 1,4-butanediol, dipropylene glycol, 1,2-butylene glycol, 2,3-butylene glycol, 1,6-hexanediol, neopentylglycol, tripropylene glycol, 1,2-ethylhexyldiol, ethylene diamine, 1,4-butylenediamine, 1,6-hexamethylenediamine, 1,5-pentanediol, 1,3-cyclohexandiol, 1,4-cyclohexanediol; 1,3-cyclohexane dimethanol, 1,4-cyclohexane dimethanol, N-methylethanolamine, N-methyliso-propylamine, 4-aminocyclohexanol, 1,2-diaminotheane, 1,3-diaminopropane, hexylmethylene diamine, methylene bis(aminocyclohexane), isophorone diamine, 1,3-bis(aminomethyl), 1,4-bis(aminomethyl)cyclohexane, diethylenetriamine, 3,5-diethyltoluene-2,4-diamine and 3,5-diethyltoluene-2,6-diamine, dimethylthiotoluenediamine (DMTDA), diethyltoluenediamine (DETDA), or dimethylthiotoluenediamine (DMTDA); and
combination of (a) a polyester polyol which is the reaction product of: (i) one or more hydrophobic monomers comprising at least one of dimer acids, dimer diols, hydroxy stearic acid, and hydroxymethylated fatty acids or esters thereof, (ii) one or more organic acids, and (iii) one or more alcohols having an OH functionality of 2 or more, and (b) one or more polycarbonate polyols.

In some embodiments:
the one or more organic acids is adipic acid and the one more alcohols is at least one of 1,4-butanediol and 1,6 hexanediol;
the one or more organic polyisocyanate components are selected from one or more of a polymeric polyisocyanates, aromatic isocyanates, cycloaliphatic isocyanates, or aliphatic isocyanates;
the one or more organic polyisocyanate components is a mixture of 4,4′-methylene diphenyl diisocyanate and 2,4′-methylene diphenyl diisocyanate;
a coating, adhesive or binding composition is formed from the hydrophobic prepolymer or hydrophobic elastomer;
the elastomer has a water uptake of less than 2 wt. % after 14 days in boiling water;
the one or more organic acids are selected from one or more of phthalic acid, isophthalic acid, terephthalic acid, trimellitic acid, tetrahydrophthalic acid, hexahydrophthalic acid, tetrachlorophthalic acid, oxalic acid, adipic acid, azelaic acid, sebacic acid, succinic acid, malic acid, glutaric acid, malonic acid, pimelic acid, suberic acid, 2,2-dimethylsuccinic acid, 3,3-dimethylglutaric acid, 2,2-dimethylglutaric acid, maleic acid, fumaric acid, itaconic acid, or fatty acids;
the one or more alcohols having an OH functionality of 2 or more are selected from one or more of ethylene glycol, propylene glycol, 1,2-butylene glycol, 2,3-butylene glycol, 1,3-propanediol, 1,3-butanediol, 1,4-butanediol, 1,6-hexanediol, neopentylglycol, 1,2-ethylhexyldiol, 1,5-pentanediol, 1,10-decanediol, 1,3-cyclohexanedimethanol, 1,4-cyclohexanedimethanol (CHDM), glycerine, or trimethylolpropane;
one or more polycarbonate polyols are the reaction product of at least (a) one or more alkane diols having 2 to 20 carbon atoms with a number average molecular weight between 500 and 3,000, and (b) at least one carbonate compound;
the one or more alkane diols are selected from one or more of 1,3-propanediol, 1,4-butanediol, 1,5-pentanediol, 1,6-hexandiol, 1,7-heptanediol, 1,2-dodecanediol, cyclohexanedimethanol, 3-methyl-1,5-pentanediol, 2,4-diethyl-1,5-pentanediol, bis(2-hydroxyethyl)ether, bis(6-hydroxyhexyl)ether, or short-chain C₂, C₃ or C₄ polyether diols having a number average molecular weight of less than 700 g/mol; and
at least one carbonate compound is selected from one or more of alkylene carbonates, diaryl carbonates, dialkyl carbonates, dioxolanones, hexanediol bis-chlorocarbonates, phosgene, or urea.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a plot comparing water uptake after a water ageing test for a polyester-polycarbonate (PE-PC) based elastomer formed according to embodiments described herein, a pure ester elastomer, and a polycarbonate polyester based on hexanediol-1,6 E-caprolactone (PCL-PC Ester) based elastomer;

FIG. 2 is a plot comparing the percent change in tensile strength after a water ageing test for the PE-PC based elastomer formed according to embodiments described herein, the pure ester elastomer, and the PCL-PC Ester based elastomer;

FIG. 3 is a plot comparing the percent weight change after prolonged exposure to ethanol for the PE-PC based elastomer formed according to embodiments described herein, the pure ester elastomer, and the PCL-PC Ester based elastomer; and

FIG. 4 is a plot comparing viscosity verses temperature for the PE-PC polyol formed according to embodiments described herein, the pure ester based polyol, and the PCL-PC Ester based polyol.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the invention generally relate to elastomers and prepolymers. More particularly, embodiments of the invention relate to elastomers and prepolymers as well as polyurethanes made from the elastomers and prepolymers having excellent hydrolytic stability. Polyester-polycarbonate polyols have been synthesized which are both amorphous and liquid at room temperature and have excellent hydrolytic stability. The hydrolytic and chemical performance of the polyester-polycarbonate polyols described herein is superior to that of commercially available hydrophobically modified polyester polyols and to that of commercially available polyester-polycarbonate polyols as described herein.

Liquid polyols which have excellent UV, hydrolytic, oxidative and chemical stability are required for various CASE applications. The embodiments described herein provide prepolymers, elastomers, and polyols which posses the aforementioned properties. Currently available copolymers of polycarbonates and esters provide a cost effective route for producing liquid polyols having most of the desired attributes but still suffer from poor hydrolytic stability. Copolymers of polycarbonates and lactones such as caprolactone (PCL-PC) are commercially available but suffer from poor hydrolytic stability at elevated temperatures. Embodiments of the polyols and prepolymers described herein provide a copolymer comprising a polycarbonate polyol and hydrophobic polyester (e.g., 1,4-butanediol based PC) comprising a hydrophobic monomer comprising at least one of a dimer acid based ester, dimer diol based ester, a hydroxy stearic acid based ester, and hydroxymethylated fatty acids and esters thereof that are hydrolytically stable and have improved chemical properties compared to commercially available PCL-PC copolymers. It has been found by the inventors that the viscosity of the final copolymer may be tuned by changing the monomers used in the synthesis of the PC or Polyester. It has also been found by the inventors that the use of 1,4-butanediol based PC is not only more cost effective, but also increases the concentration of carbonate linkages in the backbone which improves the chemical resistance of the final copolymer.

The term “prepolymer” as used herein designates a reaction product of polyol with excess isocyanate which has remaining reactive isocyanate functional groups to react with additional isocyanate reactive groups to form a polymer.

The term “NCO Index” means isocyanate index, and is the equivalents of isocyanate, divided by the total equivalents of isocyanate-reactive hydrogen containing materials, multiplied by 100. Considered in another way, it is the ratio of isocyanate-groups over isocyanate-reactive hydrogen atoms present in a formulation, given as a percentage. Thus, the isocyanate index expresses the percentage of isocyanate actually used in a formulation with respect to the amount of isocyanate theoretically required for reacting with the amount of isocyanate-reactive hydrogen used in a formulation.

The term “OH functionality” is used herein to refer to the average number of active hydroxyl groups on a molecule.

In one embodiment, a hydrophobic polyester-polycarbonate polyol which is the reaction product of (a) one or more hydrophobic polyester polyols and (b) one or more polycarbonate polyols is provided.

The hydrophobic polyester polyol may have a number average molecular weight which is within a range from about 500 to about 4,000 or from within a range from about 1,000 to about 3,000.

Component (a) includes one or more hydrophobic polyester polyols. The one or more hydrophobic polyester polyols may be the reaction product of (i) at least one hydrophobic monomer (ii) one or more organic acids, and (iii) one or more alcohols having an OH functionality of two or more

The at least one hydrophobic monomer may include at least one of one or more dimer acids, dimer diols, hydroxy stearic acid, one or more hydroxymethylated fatty acids or esters thereof, or combinations thereof.

The one or more dimer acids may include dimer acids containing from about 18 to about 44 carbon atoms. Dimer acids (and esters thereof) are a well known commercially available class of dicarboxylic acids (or esters). They are normally prepared by dimerizing unsaturated long chain aliphatic monocarboxylic acids, usually of 13 to 22 carbon atoms, or their esters (alkyl esters). Not to be bound by theory but it is believed that the dimerization is thought to proceed by possible mechanisms which include Diels Alder, free radical, and carbonium ion mechanisms. The dimer acid material will usually contain 26 to 44 carbon atoms. Particularly, examples include dimer acids (or esters) derived from C₁₈ and C₂₂ unsaturated monocarboxylic acids (or esters) which will yield, respectively, C₃₆ and C₄₄ dimer acids (or esters). Dimer acids derived from C₁₈ unsaturated acids, which include acids such as linoleic and linolenic are particularly well known (yielding C₃₆ dimer acids). For example, DELTA 9, 11 and DELTA 9, 12 linoleic acids can dimerize to a cyclic unsaturated structure (although this is only one possible structure; other structures, including acyclic structures are also possible). The dimer acid products may also contain a proportion of trimer acids (C₅₄ acids when using C₁₈ starting acids), possibly even higher oligomers and also small amounts of the monomer acids. Several different grades of dimer acids are available from commercial sources and these differ from each other primarily in the amount of monobasic and trimer acid fractions and the degree of unsaturation. The various dimers may be selected from crude grade dimer acids, hydrogenated dimer acids, purified/hydrogenated dimer acids, and combinations thereof.

Exemplary dimer acids are available from Croda under the tradename PRIPOL™ acids and from Cognis under the tradename EMPOL® acids. Suitable commercially available products of that type include PRIPOL™ 1017 (C36 dimer fatty acid), PRIPOL™ 1013 (C36 distilled dimer fatty acid), and PRIPOL™ 1006 (hydrogenated C36 dimer fatty acid).

The dimer diols may include dimer acids which have been reduced to the corresponding dimer diols. Exemplary dimer diols are available from Croda under the tradename PRIPOL™ diols. Suitable commercially available products of that type include PRIPOL™ 2030 and PRIPOL™ 2033.

The hydroxyl stearic acid may include 12 hydroxy stearic acid (12-HSA). Saturated monobasic secondary hydroxy fatty acids, especially 12-HSA, are commercially available.

The one or more hydroxymethylated fatty acids or esters thereof may be based on or derived from renewable feedstock resources such as natural and/or genetically modified plant vegetable seed oils and/or animal source fats. Suitable hydroxymethylated fatty acids or esters thereof may be obtained through hydroformylation and hydrogenation methods such as described in U.S. Pat. Nos. 4,731,486 and 4,633,021, for example, and in U.S. Published Patent Application No. 2006/0193802.

In one embodiment the one or more hydroxymethylated fatty acids or esters thereof is a monol-rich monomer. “Monol-rich monomer” and like terms means a composition comprising at least 50, typically at least 75 and more typically at least 85, weight percent (wt. %) mono-hydroxy functional fatty acid alkyl ester such as, but not limited to, that of formula I:

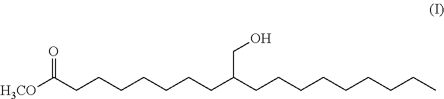 [SMILES: CCCCCCCCCC(CO)CCCCCCCC(=O)OC]

The length of the carbon backbone of formula I can vary, e.g., C₁₂-C₂₀, but it is typically C₁₈, as can the placement of the hydroxymethyl group along its length. The monol-rich monomer used in the practice of this invention can comprise a mixture of mono-hydroxy functional fatty acid alkyl esters varying in both carbon backbone length and hydroxy group placement along the length of the various carbon backbones. The monomer can also be an alkyl ester other than methyl, e.g., a C₂-C₈ alkyl ester. Other components of the composition include, but are not limited to, poly (e.g., di-, tri-, tetra-, etc.) hydroxy functional fatty acid alkyl esters.

The source of the monol-rich monomer can vary widely and includes, but is not limited to, high oleic feedstock or distillation of a low oleic feedstock, e.g., a natural seed oil such as soy as, for example, disclosed in co-pending application “PURIFICATION OF HYDROFORMYLATED AND HYDROGENATED FATTY ALKYL ESTER COMPOSITIONS” by George Frycek, Shawn Feist, Zenon Lysenko, Bruce Pynnonen and Tim Frank, filed Jun. 20, 2008, application number PCT/US08/67585, published as WO 2009/009271.

The monol-rich monomer may be derived by first hydroformylating and hydrogenating the fatty alkyl esters or acids, followed by purification to obtain monol rich monomer. Alternatively, the fatty alkyl esters or acids may first be purified to obtain mono-unsaturated rich monomer and then hydroformylated and hydrogenated.

The at least one hydrophobic monomer (i) may comprise at least 5 wt. %. 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, or 75 wt. % of the hydrophobic polyester polyol (a). The at least one hydrophobic monomer (i) may comprise up to 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, or 80 wt. % of the hydrophobic polyester polyol.

The polyester polyol (a) may include one or more organic acids (ii). The one of more organic acids may be a multifunctional organic acid. The one or more organic acids (ii) may include at least one of aliphatic acids and aromatic acids. The one or more organic acids (ii) may be selected from the group comprising for example, phthalic acid, isophthalic acid, terephthalic acid, trimellitic acid, tetrahydrophthalic acid, hexahydrophthalic acid, tetrachlorophthalic acid, oxalic acid, adipic acid, azelaic acid, sebacic acid, succinic acid, malic acid, glutaric acid, malonic acid, pimelic acid, suberic acid, 2,2-dimethylsuccinic acid, 3,3-dimethylglutaric acid, 2,2-dimethylglutaric acid, maleic acid, fumaric acid, itaconic acid, fatty acids (linolic, oleic and the like) and combinations thereof. Anhydrides of the above acids, where they exist, can also be employed. In addition, certain materials which react in a manner similar to acids to form polyester polyol oligomers are also useful. Such materials include hydroxy acids such as tartaric acid and dimethylolpropionic acid. If a triol or higher hydric alcohol is used, a monocarboxylic acid, such as acetic acid, may be used in the preparation of the polyester polyol oligomer, and for some purposes, such as polyester polyol oligomer may be desirable. Preferably, the one or more organic acids is adipic acid.

The at least one of one or organic acids (ii) may comprise at least 5 wt. %, 10 wt. %, 15 wt. %, 20 wt. %, 25 wt. %, 30 wt. %, 35 wt. %, 40 wt. %, 45 wt. %, 50 wt. %, or 55 wt. % of the hydrophobic polyester polyol (a). The at least one of one or more organic acids may comprise up to 10 wt. %, 15 wt. %, 20 wt. %, 25 wt. %, 30 wt. %, 35 wt. %, 40 wt. %, 45 wt. %, 50 wt. %, 55 wt. %, or 60 wt. % of the hydrophobic polyester polyol.

The polyester polyol (a) may include one or more alcohols (iii) having an OH functionality of 2 or more. Examples of di- and multifunctional alcohols include ethylene glycol, propylene glycol, 1,2-butylene glycol, 2,3-butylene glycol, 1,3-propanediol, 1,3-butanediol, 1,4-butanediol, 1,6-hexanediol, neopentylglycol, 1,2-ethylhexyldiol, 1,5-pentanediol, 1,10-decanediol, 1,3-cyclohexanedimethanol, 1,4-cyclohexanedimethanol (CHDM), glycerine, trimethylolpropane and combinations thereof.

The one or more alcohols (iii) may comprise at least 5 wt. %, 10 wt. %, 15 wt. %, 20 wt. %, 25 wt. %, 30 wt. %, 35 wt. %, 40 wt. %, or 45 wt. % of the hydrophobic polyester polyol (a). The one or more alcohols (iii) may comprise up to 10 wt. %, 15 wt. %, 20 wt. %, 25 wt. %, 30 wt. %, 35 wt. %, 40 wt. %, 45 wt. %, or 50 wt. % of the hydrophobic polyester polyol.

Preferably, the hydrophobic polyester polyol is made by reacting adipic acid, hexanediol, dimer acids, and a titanium acetylacetonate catalyst.

The polyester polyol may be formed by a polymerization reaction. With respect to the method for performing the polymerization reaction, there is no particular limitation, and the polymerization reaction can be performed by using conventional methods known in the art. The polymerization reaction may be aided by a catalyst. Examples of the catalyst may include metals such as lithium, sodium, potassium, rubidium, cesium, magnesium, calcium, strontium, barium, titanium, zirconium, hafnium, cobalt, zinc, aluminum, germanium, tin, lead, antimony, arsenic, and cerium and compounds thereof. As the metallic compounds, oxides, hydroxides, salts, alkoxides, organic compounds, and the like may be mentioned. Of these catalysts, it is preferred to use titanium compounds such as titanium tetrabutoxide, titanium tetra-n-propoxide, titanium tetra-isopropoxide, titanium 2-ethyl hexanoate, and titanium acetylacetonate tin compounds such as di-n-butyltin dilaurate, di-n-butyltin oxide, and dibutyltin diacetate, lead compounds such as lead acetate and lead stearate. Exemplary titanium catalysts are available from DUPONT™ under the tradename TYZOR® titanium acetylacetonates. Suitable commercially available products of that type include TYZOR® AA-105.

The polyester polyol (a) may comprise at least 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, or 90 wt. % of the hydrophobic polyester-polycarbonate polyol. The polyester polyol (a) may comprise up to 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, or 95 wt. % of the hydrophobic polyester-polycarbonate polyol.

Component (b) may comprise one or more polycarbonate polyols. The one or more polycarbonate polyols may comprise repeating units from one or more alkane diols having 2 to 50 carbon atoms. The one or more polycarbonate polyols may comprise repeating units from one or more alkane diols having 2 to 20 carbon atoms. The one or more polycarbonate polyols may be difunctional polycarbonate polyols.

The one or more polycarbonate polyols may have a number average molecular weight from about 500 to about 5,000, preferably, from about 500 to about 3,000, more preferably, from about 1,000 to about 3,000.

The one or more polycarbonate polyols may have a hydroxyl number average from about 22 to about 220 mg KOH/g, for example, from about 51 to 61 mg KOH/g.

The one or more polycarbonate polyols may have a viscosity from about 4,000 to about 15,000 centipose (cp) measured at 60 degrees Celsius by parallel plate rheometry.

The one or more polycarbonate polyols (b) may be prepared by reacting at least one polyol mixture comprising (i) one or more alkane diols (ii) with at least one organic carbonate. The one or more polycarbonate polyols may be obtained by subjecting the at least one polyol mixture and the at least one carbonate compound to a polymerization reaction. With respect to the method for performing the polymerization reaction, there is no particular limitation, and the polymerization reaction can be performed by using conventional methods known in the art.

The one or more alkane diols (i) may be selected from the group comprising: aliphatic diols having 4 to 50 carbon atoms in the chain (branched or unbranched) which may also be interrupted by additional heteroatoms such as oxygen (O), sulfur (S) or nitrogen (N). Examples of suitable diols are 1,3-propanediol, 1,4-butanediol, 1,5-pentanediol, 1,6-hexandiol, 1,7-heptanediol, 1,2-dodecanediol, cyclohexanedimethanol, 3-methyl-1,5-pentanediol, 2,4-diethyl-1,5-pentanediol, bis(2-hydroxyethyl)ether, bis(6-hydroxyhexyl)ether or short-chain C₂, C₃ or C₄ polyether diols having a number average molecular weight of less than 700 g/mol, combinations thereof, and isomers thereof. The alkane diols (i) may also include the dimer diols described above.

The at least one carbonate compound (II) may be selected from alkylene carbonates, diaryl carbonates, dialkyl carbonates, dioxolanones, hexanediol bis-chlorocarbonates, phosgene and urea. Examples of suitable alkylene carbonates may include ethylene carbonate, trimethylene carbonate, 1,2-propylene carbonate, 5-methyl-1,3-dioxane-2-one, 1,2-butylene carbonate, 1,3-butylene carbonate, 1,2-pentylene carbonate, and the like. Examples of suitable dialkyl carbonates may include dimethyl carbonate, diethyl carbonate, di-n-butyl carbonate, and the like and the diaryl carbonates may include diphenyl carbonate.

The polymerization reaction for the difunctional polycarbonate polyol may be aided by a catalyst. The polymerization reaction may be a transesterification reaction. In a transesterification reaction, one preferably contacts reactants in the presence of a transesterification catalyst and under reaction conditions. In principle, all soluble catalysts which are known for transesterification reactions may be used as catalysts (homogeneous catalysis), and heterogeneous transesterification catalysts can also be used. The process according to the invention is preferably conducted in the presence of a catalyst.

Hydroxides, oxides, metal alcoholates, carbonates and organometallic compounds of metals of main groups I, II, III and IV of the periodic table of the elements, of subgroups III and IV, and elements from the rare earth group, particularly compounds of Ti, Zr, Pb, Sn and Sb, are particularly suitable for the processes described herein.

Suitable examples include: LiOH, Li₂CO₃, K₂CO₃, KOH, NaOH, KOMe, NaOMe, MeOMgOAc, CaO, BaO, KOt-Bu, TiCl₄, titanium tetraalcoholates or terephthalates, zirconium tetraalcoholates, tin octoate, dibutyltin dilaurate, dibutyltin, bistributyltin oxide, tin oxalate, lead stearate, antimony trioxide, and zirconium tetraisopropylate.

Aromatic nitrogen heterocycles can also be used in the process described herein, as can tertiary amines corresponding to R₁R₂R₃N, where R₁₋₃ independently represents a C₁-C₃₀ hydroxyalkyl, a C₄-C₃₀ aryl or a C₁-C₃₀ alkyl, particularly trimethylamine, triethylamine, tributylamine, N,N-dimethylcyclohexylamine, N,N-dimethyl-ethanolamine, 1,8-diaza-bicyclo-(5.4.0)undec-7-ene, 1,4-diazabicyclo-(2.2.2)octane, 1,2-bis(N,N-dimethyl-amino)-ethane, 1,3-bis(N-dimethyl-amino)propane and pyridine.

Alcoholates and hydroxides of sodium and potassium (NaOH, KOH, KOMe, NaOMe), alcoholates of titanium, tin or zirconium (e.g. Ti(OPr)₄), as well as organotin compounds are preferably used, wherein titanium, tin and zirconium tetraalcoholates are preferably used with diols which contain ester functions or with mixtures of diols with lactones.

The amount of catalyst present depends on the type of catalyst and the amount of catalyst. In certain embodiments described herein, the homogeneous catalyst is used in concentrations (expressed as percent by weight of metal with respect to the aliphatic diol used) of up to 1,000 ppm (0.1%), preferably between 1 ppm and 500 ppm (0.05%), most preferably between 5 ppm and 100 ppm (0.01%). After the reaction is complete, the catalyst may be left in the product, or can be separated, neutralized or masked. The catalyst may be left in the product.

Temperatures for the transesterification reaction may be between 120 degrees Celsius and 240 degrees Celsius. The transesterification reaction is typically performed at atmospheric pressure but lower or higher pressures may be used. Vacuum may be applied at the end of the activation cycle to remove any volatiles. Reaction time depends on variables such as temperature, pressure, type of catalyst and catalyst concentration.

Exemplary polycarbonate polyols comprising repeating units from one or more alkane diol components are available from Arch Chemicals, Inc., under the trade name Poly-CD™ 220 carbonate diol and from Bayer MaterialScience, LLC, under the tradename DESMOPHEN® polyols.

The one or more polycarbonate polyols (b) may comprise at least 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, or 90 wt. % of the hydrophobic polyester-polycarbonate polyol. The one or more polycarbonate polyols (b) may comprise up to 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, or 95 wt. % of the hydrophobic polyester-polycarbonate polyol.

The polyester-polycarbonate polyol may be prepared by subjecting the one or more polyols (a) and the one or more polycarbonate polyols (b) to a polymerization reaction. The polymerization reaction may be a transesterification reaction. In principle, all soluble catalysts which are known for transesterification reactions may be used as catalysts (homogeneous catalysis), and heterogeneous transesterification catalysts can also be used. The exemplary catalysts described above for formation of the polycarbonate polyol may also be used for formation of the polyester-polycarbonate polyol.

As described above, temperatures for the transesterification reaction may be between 120 degrees Celsius and 240 degrees Celsius. The transesterification reaction is typically performed at atmospheric pressure but lower or higher pressures may also be useful Vacuum may be applied at the end of the activation cycle to remove any volatiles. Reaction time depends on variables such as temperature, pressure, type of catalyst and catalyst concentration. In certain embodiments, where titanium catalysts are used in the production of the polycarbonate polyol, any residual titanium catalyst in the polycarbonate may assist with the transesterification reaction for formation of the polyester-polycarbonate polyol.

Prepolymer or Elastomer Composition:

In another embodiment, a hydrophobic prepolymer or elastomer is provided. The elastomer or prepolymer is prepared from a reaction system comprising (a) a hydrophobic polyester-polycarbonate polyol and (b) one or more organic polyisocyanates.

Component (a) may comprise the hydrophobic polyester-polycarbonate polyol as previously described herein.

The hydrophobic polyester-polycarbonate polyol (a) may comprise at least 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, or 90 wt. % of the elastomer composition. The hydrophobic polyester-polycarbonate polyol (a) may comprise up to 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, or 95 wt. % of the elastomer composition.

Component (b) may comprise one or more organic polyisocyanate components. The isocyanate functionality is preferably from about 1.9 to 4, and more preferably from 1.9 to 3.5 and especially from 2.0 to 3.3. The one or more organic polyisocyanate components may be selected from the group comprising a polymeric polyisocyanate, aromatic isocyanate, cycloaliphatic isocyanate, or aliphatic isocyanates. Exemplary polyisocyanates include, for example, m-phenylene diisocyanate, 2,4- and/or 2,6-toluene diisocyanate (TDI), the various isomers of diphenylmethanediisocyanate (MDI), and polyisocyanates having more than 2 isocyanate groups, preferably MDI and derivatives of MDI such as biuret-modified “liquid” MDI products and polymeric MDI (PMDI), 1,3 and 1,4-(bis isocyanatomethyl)cyclohexane, isophorone diisocyanate (IPDI), hexamethylene diisocyanate (HDI), bis(4-isocyanatocyclohexyl)methane or 4,4′ dimethylene dicyclohexyl diisocyanate (H12MDI), and combinations thereof, as well as mixtures of the 2,4- and 2,6-isomers of TDI, with the former most preferred in the practice of the invention. A 65/35 weight percent mixture of the 2,4 isomer to the 2,6 TDI isomer is typically used, but the 80/20 weight percent mixture of the 2,4 isomer to the 2,6 TDI isomer is also useful in the practice of this invention and is preferred based on availability. Suitable TDI products are available under the trade name VORANATE™ which is available from The Dow Chemical Company. Preferred isocyanates include methylene diphenyl diisocyanate (MDI) and or its polymeric form (PMDI) for producing the prepolymers described herein. MDI products are available from The Dow Chemical Company under the trade names PAPI®, VORANATE® and ISONATE®. Suitable commercially available products of that type include PAPI™ 94, PAPI™ 27, and ISONATE M125 which are also available from The Dow Chemical Company.

The one or more organic polyisocyanate components (b) may comprise at least 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, or 90 wt. % of the elastomer composition. The one or more organic polyisocyanate components (b) may comprise up to 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, or 95 wt. % of the elastomer composition.

For elastomers, coating and adhesives the isocyanate index is generally between 80 and 125, preferably between 90 to 110. For prepolymers the isocyanate index is generally between 200 and 5,000, preferably between 200 to 2,000.

The reaction system may further comprise one or more chain extenders (c). The chain extender is typically used in small quantities such as up to 20 wt. %, especially up to 3 wt. % of the total reaction system. In certain embodiments, the chain extender is from 0.015 to 5 wt. % of the total reaction system. Representative chain extenders include ethylene glycol, diethylene glycol, 1,3-propane diol, 1,3-butanediol, 1,4-butanediol, dipropylene glycol, 1,2-butylene glycol, 2,3-butylene glycol, 1,6-hexanediol, neopentylglycol, tripropylene glycol, 1,2-ethylhexyldiol, ethylene diamine, 1,4-butylenediamine, 1,6-hexamethylenediamine, 1,5-pentanediol, 1,3-cyclohexandiol, 1,4-cyclohexanediol; 1,3-cyclohexane dimethanol, 1,4-cyclohexane dimethanol, N-methylethanolamine, N-methyliso-propylamine, 4-aminocyclohexanol, 1,2-diaminotheane, 1,3-diaminopropane, hexylmethylene diamine, methylene bis(aminocyclohexane), isophorone diamine, 1,3-bis(aminomethyl), 1,4-bis(aminomethyl)cyclohexane, diethylenetriamine, 3,5-diethyltoluene-2,4-diamine and 3,5-diethyltoluene-2,6-diamine, and mixtures or blends thereof. Suitable primary diamines include for example dimethylthiotoluenediamine (DMTDA) such as Ethacure 300 from Albermarle Corporation, diethyltoluenediamine (DETDA) such as Ethacure 100 from Albemarle (a mixture of 3,5-diethyltoluene-2,4-diamine and 3,5-diethyltoluene-2,6-diamine), isophorone diamine (IPDA), and dimethylthiotoluenediamine (DMTDA).

The reaction system may further comprise one or more catalyst components (d). Catalysts are typically used in small amounts, for example, each catalyst being employed from 0.0015 to 5 wt. % of the total reaction system. The amount depends on the catalyst or mixture of catalysts and the reactivity of the polyols and isocyanate as well as other factors familiar to those skilled in the art.

Although any suitable catalyst may be used. A wide variety of materials are known to catalyze polyurethane reactions including amine-based catalysts and tin-based catalysts. Preferred catalysts include tertiary amine catalysts and organotin catalysts. Examples of commercially available tertiary amine catalysts include: trimethylamine, triethylamine, N-methylmorpholine, N-ethylmorpholine, N,N-dimethylbenzylamine, N,N-dimethylethanolamine, N,N-dimethylaminoethyl, N,N,N′,N′-tetramethyl-1,4-butanediamine, N,N-dimethylpiperazine, 1,4-diazobicyclo-2,2,2-octane, bis(dimethylaminoethyl)ether, triethylenediamine and dimethylalkylamines where the alkyl group contains from 4 to 18 carbon atoms. Mixtures of these tertiary amine catalysts are often used.

Examples of commercially available amine catalysts include NIAX™ A1 and NIAX™ A99 (bis(dimethylaminoethyl)ether in propylene glycol available from Momentive Performance Materials), NIAX™ B9 (N,N-dimethylpiperazine and N—N-dimethylhexadecylamine in a polyalkylene oxide polyol, available from Momentive Performance Materials), DABCO® 8264 (a mixture of bis(dimethylaminoethyl)ether, triethylenediamine and dimethylhydroxyethyl amine in dipropylene glycol, available from Air Products and Chemicals), DABCO® 33LV (triethylene diamine in dipropylene glycol, available from Air Products and Chemicals), DABCO® BL-11 (a 70% bis-dimethylaminoethyl ether solution in dipropylene glycol, available from Air Products and Chemicals, Inc), NIAX™ A-400 (a proprietary tertiary amine/carboxylic salt and bis(2-dimethylaminoethyl)ether in water and a proprietary hydroxyl compound, available from Momentive Performance Materials); NIAX™ A-300 (a proprietary tertiary amine/carboxylic salt and triethylenediamine in water, available from Momentive Performance Materials); POLYCAT® 58 (a proprietary amine catalyst available from Air Products and Chemicals), POLYCAT® 5 (pentamethyl diethylene triamine, available from Air Products and Chemicals) POLYCAT® 8 (N,N-dimethyl cyclohexylamine, available from Air Products and Chemicals) and POLYCAT® 41 (a proprietary amine catalyst available from Air Products and Chemicals).

Examples of organotin catalysts are stannic chloride, stannous chloride, stannous octoate, stannous oleate, dimethyltin dilaurate, dibutyltin dilaurate, other organotin compounds of the formula SnRₙ(OR)₄₋ₙ, wherein R is alkyl or aryl and n is 0-2, and the like. Organotin catalysts are generally used in conjunction with one or more tertiary amine catalysts, if used at all. Commercially available organotin catalysts of interest include KOSMOS® 29 (stannous octoate from Evonik AG), DABCO® T-9 and T-95 catalysts (both stannous octoate compositions available from Air Products and Chemicals).

Additives such as surface active agents, antistatic agents, plasticizers, fillers, flame retardants, pigments, stabilizers such as antioxidants, fungistatic and bacteriostatic substances and the like are optionally used in the reaction system.

### EXAMPLES

Objects and advantages of the embodiments described herein are further illustrated by the following examples. The particular materials and amounts thereof, as well as other conditions and details, recited in these examples should not be used to limit embodiments described herein. Unless stated otherwise all percentages, parts and ratios are by weight. Examples of the invention are numbered while comparative samples, which are not examples of the invention, are designated alphabetically.

A description of the raw materials used in the examples is as follows.

The alkane diol is 1,4-butane diol (BDO) which is commercially available from SIGMA-ALDRICH®.

The titanium catalyst is TYZOR® TPT (tetra-isopropyl titanate) catalyst which is a reactive organic alkoxy titanate with 100% active content commercially available from DuPont.

The dimethyl carbonate (DMC) is commercially available from KOWA American Corporation.

Adipic acid (AA) is commercially available from SIGMA ALDRICH®.

Hexane diol (HDO) is commercially available from SIGMA ALDRICH®.

12-hydroxy stearic acid (12-HSA) is commercially available from Royal Castor Products Ltd.

Dimer acid A is a hydrogenated dimer acid having an acid value from about 194 to 198 mgKOH/g and is commercially available as PRIPOL™ 1006 from Croda.

Dimer acid B has an acid value from about 194 to 198 mgKOH/g and is commercially available as PRIPOL™ 1013 from Croda.

Dimer acid C has an acid value from about 190 to 197 mgKOH/g and is commercially available as PRIPOL™ 1017 from Croda.

The titanium catalyst is TYZOR® AA-105 (acetylacetonates) catalyst which is a reactive titanium acetylacetonate chelate commercially available from DuPont.

The isocyanate is ISONATE® M125 which is approximately 98/2 weight percent of 4,4′-/2,4′-Methylene diphenyl diisocyanate available from The Dow Chemical Company.

Dibutyl tin dilaurate is commercially available from SIGMA ALDRICH®.

DESMOPHEN® C 1200 (PCL-PC copolymer) is a linear aliphatic polycarbonate polyester based on hexane diol-1,6 E-caprolactone with an average molecular weight of approximately 2,000 commercially available from Bayer MaterialScience.

Synthesis of Butanediol Based PC Polyol (BDPC)

A 1,000 mL four-neck round-bottom flask was equipped with a Dean-Stark trap, thermocouple, and mechanical stirrer. The fourth port was used to add dimethyl carbonate (DMC). The flask was heated with a heating mantle and monitored in the reaction via the thermocouple. 635 g of butane diol (7.055 mol) was added to the flask and was heated to 150 degrees Celsius while sweeping with N₂ to inert the flask and remove water present in the butane diol. TYZOR® TPT catalyst (188 mg) was added via syringe to the reaction flask. DMC was added via peristaltic pump and within 45 minutes DMC and methanol began to distill over at 62 degrees Celsius. In total, 1,079 g of DMC (11.994 mol, 1.7 eq wrt BDO) was added at a rate sufficient to maintain the overhead temperature between 62 to 65 degrees Celsius. Upon completion of the DMC add, the temperature was increased, in 10 degrees Celsius increments, to 200 degrees Celsius. Upon reaching 200 degrees Celsius, the pot temp was immediately reduced to 170 degrees Celsius and a nitrogen sweep was begun (overnight). The molecular weight (Mn) was found to be 3,065 g/mol (pdi 2.28) by GPC analysis and 3,660 g/mol via 1H NMR end-group analysis.

Next 20.86 g of butane diol (BDO) was added to the reaction mixture with stirring at 170 degrees Celsius. After two hours of reaction under these conditions, the Mn was found to be 1,590 g/mol by 1H NMR end-group analysis with 9 mole % carbonate end-groups. The reaction pressure was reduced to 120 torr and the reaction was stirred at 180 degrees Celsius for two hours resulting in an increase in molecular weight to 2,159 g/mol (1H NMR end-group analysis) with 3.9 mole % carbonate end-groups. BDO (3.0 g) was added and the reaction was stirred at 170 degrees Celsius for two hours before reducing the pressure to 80 torr and increasing the temperature to 200 degrees Celsius for an additional two hours. The molecular weight increased to 2,275 g/mol (1H NMR end-group analysis) and the hydroxyl number was determined to be 49.36 mg KOH/g. A final BDO add of 4.0 g was made and the reaction was stirred for an additional two hours at 180 degrees Celsius. The molecular weight was reduced to 1,773 g/mol (1H NMR end-group analysis) and the carbonate end-groups were non-detect by 1H NMR. The hydroxyl number of the final polymer was 55 mg KOH/g.

TABLE I
Butane Diol Polycarbonate (BDPC) Polyol Formulations:

| Raw Materials | Amount |
|---|---|
| Alkane Diol | 662.86 g |
| Titanium Catalyst | 188 mg |
| Dimethyl Carbonate | 1079 g |

Table I: BDPC formulations.

Synthesis of 1,6 Polyester (PE)

A designated amount of raw materials (see Table II) were added into a 4 neck-round bottom flask, and then the flask was placed on the heating mantle and the mechanical stirrer was set up on the center neck. A nitrogen gas needle was inserted through the rubber septum with the nitrogen flow rate at 0.1 L/min. In order to remove the by-product (H₂O) effectively as well as selectively (i.e. minimizing raw material losses), the specially designed separation column (vacuum jacketed column) was utilized. The water by-product was collected using a distilling head. The reaction temperature was controlled by the temperature controller which was connected with a thermocouple and a heating mantle. The reaction temperature was set at 210 degrees Celsius. The raw materials were melted before applying mechanical stirring condition, and then the reaction was started with a mild stirring condition (300 rpm) and lower nitrogen stripping rate (0.1 L/min) to minimize the loss of raw materials. When the reaction achieved 80 to 90% conversion, both stirring and nitrogen gas stripping rate were increased up to 600 rpm and 0.7 L/min, respectively, until the reaction was completed. The reaction was monitored by measuring acidity, and was regarded as complete when the acidity become less than 2 mgKOH/g.

TABLE II
Polyester Polyol Formulations:

| Raw Materials | 1 | 2 | 3 |
|---|---|---|---|
| Adipic Acid | 29.17 | 31.3 | 29.29 |
| Hexane diol | 36.28 | 33.6 | 36.17 |
| (HDO) | | | |
| Dimer Acid A | 34.55 | | |
| Dimer Acid B | | 34.55 | |
| Dimer Acid C | | | 34.55 |
| Titanium Catalyst | 50 ppm | 50 ppm | 50 ppm |

Table II: PE polyol formulations.

Synthesis of Polyester Polycarbonate (PE-PC) Polyol Via Transesterification Route

600 g each of BDPC and 1,6-Polyester Polyol was weighed in a 3 L flask. The mixture was heated to 185 degrees Celsius for six hours under nitrogen. The mixture was cooled to 100 degrees Celsius and 0.26 g of dibutyl phosphate was added to quench the residual Ti catalyst. The resulting polyol was mixed for one hour. Vacuum was applied for 30 minutes to strip off any volatiles.

TABLE III
Polyester Polycarbonate (PE-PC) Formulations:

| Raw Materials | Amount |
|---|---|
| BDPC | 600 g |
| PE Polyol | 600 g |
| Dibutyl Phosphate | 0.26 g |

Table III: PC ester formulations.

Elastomer Casting

The elastomer was made by hand mixing the PE-PC polyol and isocyanate. In a typical formulation 50 g of PE-PC polyol was mixed with 19.31 g of ISONATE® M125 (Index 1.03) at 60 degrees Celsius. The mixture was hand whipped for 30 seconds under nitrogen and then placed in an 80 degrees Celsius oven for two hours. The elastomer was cooled down to 70 degrees Celsius. 4.5 g of 1,4-butanediol and 25 ppm (based on polyol) of dibutyl tin dilaurate was added and the reaction mixture was mixed in a FLACKTEK™ mixer for 20 seconds at 2,350 rpm. The mixture was poured between two TEFLON® coated aluminum sheet and compression molded at 20,000 psi for 1 hour. The plaque was then cured overnight at 80 degrees Celsius.

TABLE IV
Elastomer Formulations:

| | | | Comparative | | Comparative | |
|---|---|---|---|---|---|---|
| Raw Materials | Example 1 | | Sample A | | Sample B | |
| PE-PC | 50 | g | | | | |
| Pure Ester | | | 50 | g | | |
| PCL-PC Ester | | | | | 50 | g |
| Chain Extender | 4.5 | g | 4.5 | g | 4.5 | g |
| Amine Catalyst | 25 | ppm | 25 | ppm | 25 | ppm |
| Isocyanate | 19.31 | g | 19.31 | g | 19.31 | g |

Table IV: Elastomer Formulations.

Elastomers with pure ester (Comparative Sample A) and PCL-PC Ester based on DESMOPHEN® C 1200 (Comparative Sample B) were prepared in a similar fashion for comparison.

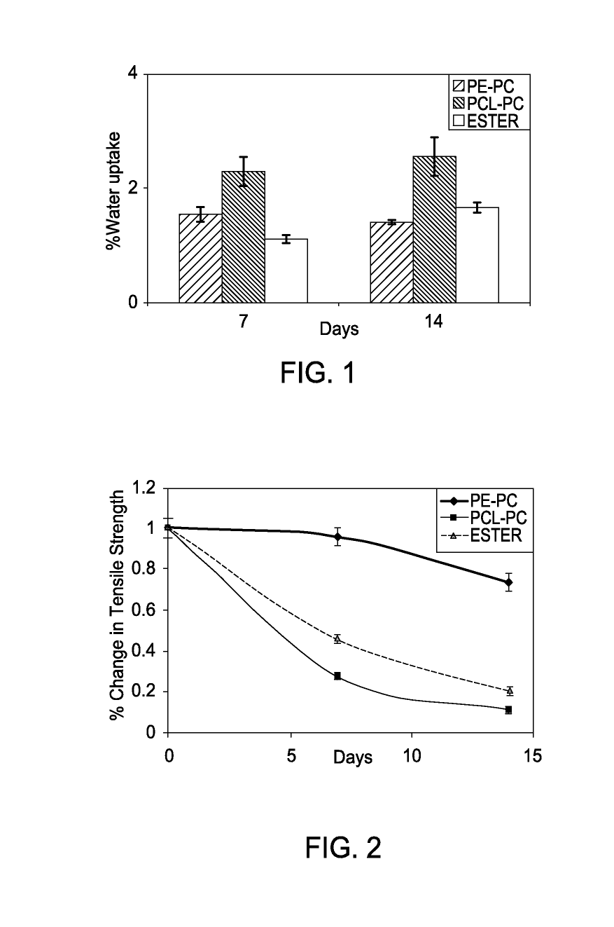

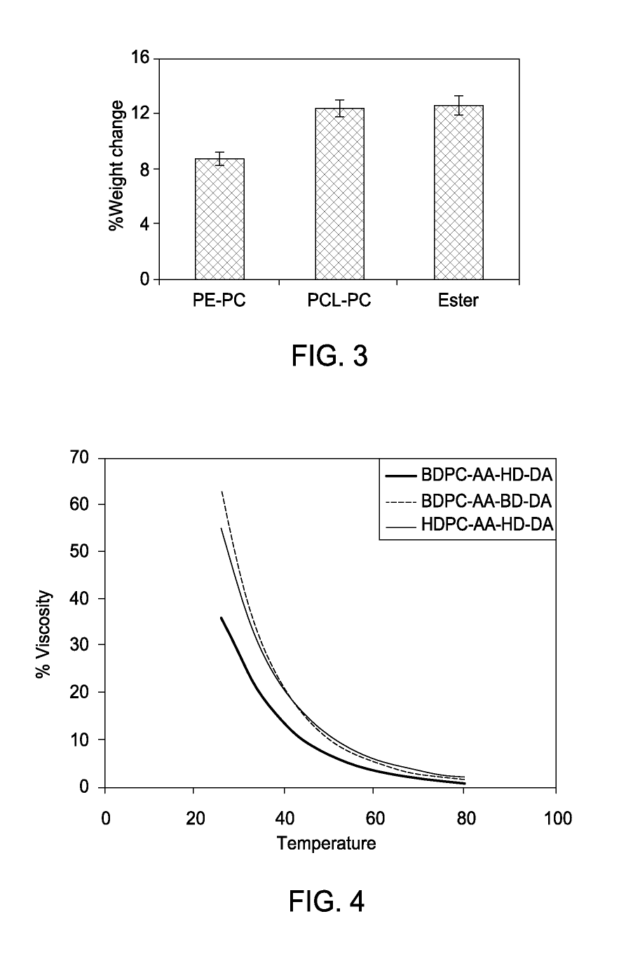

Dogbone shaped samples with a width of 0.815″ and length of 0.827″ of each of the elastomers were prepared. The hydrolytic stability of each sample was measured by soaking the elastomer dogbones in boiling water for a period of two weeks. As shown in FIG. 1, the water uptake in the dimer based PE-PC based elastomer (Example #1) is lower by 40% as compared to PCL-PC ester based elastomer (Comparative Sample B) due to the presence of hydrophobic moieties in the dimer based PE-PC based elastomer. With reference to FIG. 2, this results in excellent hydrolytic stability as indicated by loss of only 30% of the tensile strength for the dimer based PE-PC based elastomer verses 90% loss of tensile strength for the PCL-PC ester based elastomer (Comparative Sample B) after the boiling water immersion test. Not to be bound by theory, but it is believed that the PE-PC based elastomer is more water stable than the pure ester based elastomer (Comparative Sample A) due to the presence of carbonate linkages in the backbone of the PE-PC based elastomer. Ethanol resistance was also measured by soaking the dog bones in ethanol at room temperature and measuring the change in weight of each dog bone sample. As shown in FIG. 3, the PE-PC based elastomer has 40% lower ethanol uptake when compared with the PCL-PC ester based elastomer (Comparative Sample B) and the pure ester based elastomer (Comparative Sample A).

Other aspect of this study found that it is possible to fine tune the viscosity of the material by changing the monomer used in making at least one of the polycarbonate and the polyester. As shown in FIG. 4, the viscosity of the material is high if butanediol is used to synthesize both the polycarbonate and the ester while it is low when butanediol is used to make the polycarbonate and hexanediol is used to make the ester. This understanding gives us the option to fine tune the viscosity for a given application.

While the foregoing is directed to embodiments of the invention, other and further embodiments of the invention may be devised without departing from the basic scope thereof.

What is claimed is:

1. A hydrophobic polyester-polycarbonate polyol which is the reaction product of:
(a) a polyester polyol which is the reaction product of:
(i) one or more hydrophobic monomers;
(ii) one or more organic acids; and
(iii) one or more alcohols having an OH functionality of 2 or more; and
(b) one or more polycarbonate polyols.

2. The hydrophobic polyester-polycarbonate polyol of claim 1, wherein the one or more hydrophobic monomers comprises at least one of dimer acids, dimer diols, hydroxy stearic acid, hydroxymethylated fatty acids, or esters thereof.

3. The hydrophobic polyester-polycarbonate polyol of claim 1, wherein the one or more organic acids are selected from phthalic acid, isophthalic acid, terephthalic acid, trimellitic acid, tetrahydrophthalic acid, hexahydrophthalic acid, tetrachlorophthalic acid, oxalic acid, adipic acid, azelaic acid, sebacic acid, succinic acid, malic acid, glutaric acid, malonic acid, pimelic acid, suberic acid, 2,2-dimethylsuccinic acid, 3,3-dimethylglutaric acid, 2,2-dimethylglutaric acid, maleic acid, fumaric acid, itaconic acid, fatty acids, or combinations thereof.

4. The hydrophobic polyester-polycarbonate polyol of claim 1, wherein the one or more alcohols having an OH functionality of 2 or more is selected from ethylene glycol, propylene glycol, 1,2-butylene glycol, 2,3-butylene glycol, 1,3-propanediol, 1,3-butanediol, 1,4-butanediol, 1,6-hexanediol, neopentylglycol, 1,2-ethylhexyldiol, 1,5-pentanediol, 1,10-decanediol, 1,3-cyclohexanedimethanol, 1,4-cyclohexanedimethanol (CHDM), glycerine, trimethylolpropane, or combinations thereof.

5. The hydrophobic polyester-polycarbonate polyol of claim 1, wherein the one or more organic acids comprises adipic acid and the one more alcohols comprises at least one of 1,4-butanediol and 1,6 hexanediol.

6. The hydrophobic polyester-polycarbonate polyol of claim 1, wherein the one or more polycarbonate polyols comprise the reaction product of at least:
(a) one or more alkane diols having 2 to 50 carbon atoms with a number average molecular weight between 500 and 3,000; and
(b) at least one carbonate compound.

7. The hydrophobic polyester-polycarbonate polyol of claim 6, wherein the one or more alkane diols is selected from 1,3-propanediol, 1,4-butanediol, 1,5-pentanediol, 1,6-hexandiol, 1,7-heptanediol, 1,2-dodecanediol, cyclohexanedimethanol, 3-methyl-1,5-pentanediol, 2,4-diethyl-1,5-pentanediol, bis(2-hydroxyethyl)ether, bis(6-hydroxyhexyl)ether, dimer diols, short-chain C₂, C₃ or C₄ polyether diols having a number average molecular weight of less than 700 g/mol, or combinations thereof.

8. The hydrophobic polyester-polycarbonate polyol of claim 7, wherein the at least one carbonate compound is selected from alkylene carbonates, diaryl carbonates, dialkyl carbonates, dioxolanones, hexanediol bis-chlorocarbonates, phosgene, urea, or combinations thereof.

9. The hydrophobic polyester-polycarbonate of claim 1, wherein the hydrophobic polyester-polycarbonate is a liquid at room temperature.

10. A hydrophobic prepolymer or hydrophobic elastomer prepared from a reaction mixture comprising:
(a) a hydrophobic polyester-polycarbonate polyol; and
(b) one or more organic polyisocyanate components.

11. The hydrophobic elastomer of claim 10, wherein the reaction mixture further comprises:
(c) one or more chain extenders.

12. The prepolymer or elastomer of claim 10, wherein the hydrophobic polyester-polycarbonate polyol comprises:
(a) a polyester polyol which is the reaction product of:
(i) one or more hydrophobic monomers comprising at least one of dimer acids, dimer diols, hydroxy stearic acid, hydroxymethylated fatty acids, or esters thereof;
(ii) one or more organic acids; and
(iii) one or more alcohols having an OH functionality of 2 or more; and
(b) one or more polycarbonate polyols.

13. The prepolymer or elastomer of claim 12, wherein the one or more organic acids is adipic acid and the one more alcohols is at least one of 1,4-butanediol and 1,6 hexanediol.

14. The prepolymer or elastomer of claim 10, wherein the one or more organic polyisocyanate components are selected from one or more of a polymeric polyisocyanates, aromatic isocyanates, cycloaliphatic isocyanates, or aliphatic isocyanates.

15. The prepolymer or elastomer of claim 14, wherein the one or more organic polyisocyanate components is a mixture of 4,4′-methylene diphenyl diisocyanate and 2,4′-methylene diphenyl diisocyanate.

16. A coating, adhesive, or binding composition formed from the prepolymer or elastomer of claim 12.

17. The hydrphobic elastomer of claim 10, wherein the elastomer has a water uptake of less than 2 wt. % after 14 days in boiling water.
